(19) United States
(12) Patent Application Publication
(10) Pub. No.: US 2016/0190663 A1
(43) Pub. Date: Jun. 30, 2016

(54) BUSBARS WITH INTEGRATED COOLING SYSTEM FOR VEHICLE BATTERY ASSEMBLIES

(71) Applicant: SIMON FRASER UNIVERSITY, Burnaby (CA)

(72) Inventors: Majid Bahrami, North Vancouver (CA); Peyman Taheri Bonab, Vancouver (CA); Todd Pratt, Pitt Meadows (CA)

(73) Assignee: SIMON FRASER UNIVERSITY, Burnaby (CA)

(21) Appl. No.: 14/878,897

(22) Filed: Oct. 8, 2015

Related U.S. Application Data
(60) Provisional application No. 62/061,840, filed on Oct. 9, 2014.

(51) Int. Cl. H01M 10/6553; H01M 10/6556; H01M 10/613; H01M 10/625; H01M 2/10; H01M 2/20

(52) U.S. Cl. CPC H01M 10/6553; H01M 2/1077; H01M 2/206; H01M 10/613; H01M 10/625; H01M 10/6556; H01M 2220/20

(57) ABSTRACT

A battery assembly includes a plurality of batteries operably positioned to be charged and discharged. At least a first battery and a second battery of the plurality of batteries include a stack of electrochemical cells encased in an electrically inert case. A pair of battery tabs outwardly extends from the case. At least the first battery and the second battery in the battery assembly are configured to be electrically connected through their battery tabs with one or more hollow busbars forming a passage for a coolant flow.

### CROSS-REFERENCE TO RELATED APPLICATION

This application claims the benefit of U.S. Provisional Patent Application No. 62/061,840, filed Oct. 9, 2014, the disclosure of which is incorporated herein by reference in its entirety.

### FIELD OF THE INVENTION

This disclosure relates generally to integration of thermal management systems into battery assemblies (packs), more particularly to batteries with high energy and power densities, and their use in items of manufacture such as electrically driven motor vehicles.

### BACKGROUND

Hybrid electric vehicles (HEVs) and fully electric vehicles (EVs) are emerging as promising solutions for near-term sustainable transportation. The deleterious effects of conventional internal combustion engines (ICEs) on the environment, and certain economical issues associated with petroleum-based fuels are the major motivations in development of electric powertrains.

While EVs completely rely on the power supply from an electrochemical storage system (e.g., batteries), in HEVs a combination of ICE power and battery system power provides the propulsion in the hybrid drivetrain. Addition of a regeneration system to the vehicle allows recharging the batteries by capturing the kinetic energy during braking. Moreover, a small ICE can be used as a generator in EVs to recharge the batteries and extend the driving range.

Hybrid and fully electric vehicles have many hurdles to overcome when it comes to safety and efficiency concerns. Despite technological achievements in battery technology, large-scale application of high-energy and high-power batteries has not reached to its full potential. This shortcoming is associated with the fact that charge intake, power delivery characteristics, and calendar life of batteries strongly depends on their temperature. It is a well-evidenced fact that excessive heating of batteries during operation (charging and discharging) leads to imbalanced reactions, which consequently trigger serious safety issues such as fire and explosion. Moreover, exposure of batteries to sub-freezing temperatures drastically reduces their power delivery. Accordingly, battery thermal management system (BTMS) is a must for all large- and medium-scale battery packs to keep their temperature within an optimal range regardless of the load on the battery pack.

Lithium-ion (Li-ion) batteries have become the dominant battery technology due to several compelling features such as high power and energy densities, long cycle life, excellent storage capabilities, and memory-free recharge characteristics. Prismatic Li-ion cells, also known as pouch-shaped cells, are well known in the art, and are favored in automobiles electrification owing to the negligible weight for the case (pouch), relatively low manufacturing costs, and flexibility in shape design.

Lithium based batteries are room temperature batteries; this means that their ideal operating temperature is around 25° C. Nonetheless, they can operate within the range of −20° C. to 60° C., but at temperatures below 0° C. their capacity fades rapidly and at temperatures above 50° C. they become prone to serious thermal hazards. Accordingly, thermal management of Li-ion batteries is critical to promote their safety and performance.

In general, complexity of a BTMS increases with the size of a battery system. Significant temperature variations can occur between individual cells, as the size of battery system increases. If one cell is at a higher temperature compared to the other cells, its electrical performance will be different, and this leads to imbalance performance of the whole battery pack. Thus, to promote the peak performance, the differential temperature between the cells in the battery pack should be minimized; meanwhile the entire battery pack must be kept within a desired temperature range.

A variety of cooling systems for Li-ion battery packs in hybrid and fully electric vehicles are proposed in the prior art. In general, cooling systems for batteries can be divided into two categories: active cooling systems, and passive cooling systems. More recently, a combination of active and passive systems is proposed (see U.S. 2012/0183830 A1).

In passive cooling systems, the coolant is a phase change material (PCM), such as waxes or wax-like materials, paraffin for example, which melts gradually by absorbing heat from batteries (see U.S. 2012/0003523 A1, U.S. 2013/0084487 A1, U.S. 2012/0258337 A1, and U.S. 2011/0081564 A1). Quite differently, in active cooling systems, heat is removed from batteries by providing a coolant flow (see U.S. 2011/0076540 A1, U.S. 2011/0008657 A1, U.S. Pat. No. 7,353,900 B2, and U.S. Pat. No. 7,560,190 B2).

The main advantage of a passive BTMS is the absence of blower/pump and flow distributors/channels in the system. However, passive cooling systems have other problems, including low thermal conductivities of PCMs, sealing issues due to expansion and contraction of PCM, and relatively heavier weight compared with an active BTMS. Increase in thermal conductivity of PCMs is the key to enhance the performance of passive systems; hence, metallic matrices such as metal foams, or thermally conductive materials such as graphite are usually combined with a PCM to increase the thermal diffusion at higher costs.

In active BTMSs, the coolant flow is preferred to be distributed over the surface of batteries. This requires addition of flow channels to the battery pack (see U.S. 2009/0258289 A1 and U.S. 2008/0299449 A1) and employment of larger pumps and blowers to overcome the pressure drop in coolant flow. Simpler active BTMS designs are also proposed that include heat spreaders and/or fins, made from aluminum alloys or graphite, to provide a thermal bridging between batteries and the coolant flow (see U.S. 2013/0157100 A1, U.S. 2013/0157101 A1, U.S. 2013/0115506 A1, and U.S. Pat. No. 7,531,270 B2).

Heat generation in batteries is not homogeneous. Experimental measurements, infrared thermographs, electro-thermal models, and thermo-electrochemical simulations confirm the significant role of ohmic resistance and excessive Joule heating at current carrying members of a battery, particularly at aggressive charge and discharge conditions. More importantly, due to current constriction at battery tabs, the contribution of Joule heating to temperature rise is more pronounced at the vicinity of tabs. A few BTMS designs are suggested (see U.S. 2009/0286141 A1, DE 10 2010051010 A1), which target hot spots of the battery.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a battery assembly includes a plurality of batteries operably positioned to be charged and discharged. At least a first battery and a second battery of the plurality of batteries include a stack of electrochemical cells encased in an electrically inert case, with a pair of battery tabs outwardly extended from the case. At least the first battery and the second battery in the battery assembly are configured to be electrically connected through their battery tabs with one or more hollow busbars forming a passage for a coolant flow.

In one example, the battery tabs are configured to be connected to the one or more hollow busbars with thermally and electrically conductive joints. In another example, the one or more hollow busbars comprise openings for coolant inlet and coolant outlet. In another example, the one or more hollow busbars are configured to electrically connect the battery tabs of adjacent batteries in the battery assembly.

In another example, the battery assembly further includes at least one flow manifold configured to be used in a stacking direction of the batteries, where the at least one flow manifold has at least one opening for coolant flow to and from an external source, and at least one opening for coolant flow to and from the one or more hollow busbars. In another example, at least one opening of the one or more hollow busbars is connected to an opening on the at least one flow manifold such that flow of coolant is permitted either from the flow manifold into the hollow busbar or from the hollow busbar into the flow manifold.

In another example, the battery assembly further includes a fan or a pump configured to drive the coolant flow within the one or more hollow busbars. In another example, the coolant is a gas or liquid and wherein a device configured to force the coolant flow is one or more of a fan, a blower, or a pump. In another example, the coolant flow inside the one or more hollow busbars is selected to be used for one of cooling or heating effects. In another example, the stack of electrochemical cells forms an electrode stack, and wherein the electrode stack comprises prismatic batteries.

In another embodiment, a busbar for use in a battery assembly includes a hollow busbar configured to form a passage for coolant flow from a coolant inlet to a coolant outlet. The busbar is configured to attach to a plurality of batteries within the battery assembly via battery tabs extending from individual batteries in order to provide thermal communication between the busbar and the plurality of batteries and to provide electrical communication between the plurality of batteries.

In one example, the battery tabs are connected to the hollow busbar with thermally and electrically conductive joints. In another example, the hollow busbar is configured to electrically connect the battery tabs of adjacent batteries in the battery assembly. In another example, the hollow busbar is configured to attach to at least one flow manifold configured to provide coolant flow through the hollow busbar. In another example, the at least one flow manifold is configured to provide coolant flow either from the flow manifold into the at least one hollow busbar or from the at least one hollow busbar into the flow manifold. In another example, the coolant is a gas or a liquid. In another example, the flow of the coolant inside the busbars is selected to be used for one of cooling and heating effects. In another example, the plurality of electrochemical cells comprises prismatic batteries.

In another embodiment, a flow manifold configured to attach to a busbar where the busbar includes a hollow busbar configured to form a passage for coolant flow from a coolant inlet to a coolant outlet, and where the busbar is configured to attach to a plurality of batteries within the battery assembly via battery tabs extending from individual batteries in order to provide thermal communication between the busbar and the plurality of batteries and to provide electrical communication between the plurality of batteries.

In one example, the flow manifold has at least one opening for a coolant flow from and to an external source, and a least one opening for coolant flow from and to a hollow busbar. In one example, the flow manifold is configured to permit the coolant flow either from the flow manifold into the hollow busbar or from the hollow busbar into the flow manifold.

In another example, a cooling system for a battery assembly includes at least one hollow busbar and at least one flow manifold in fluid communication with the at least one hollow busbar. The at least one hollow busbar is configured to form a passage for coolant flow from a coolant inlet to a coolant outlet wherein the at least one hollow busbar is configured to attach to a plurality of batteries within the battery assembly via battery tabs extending from individual batteries in order to provide thermal communication between the at least one hollow busbar and the plurality of batteries and to provide electrical communication between the plurality of batteries.

In one example, the at least one flow manifold is configured to permit the coolant flow either from the at least one flow manifold into the at least one hollow busbar or from the at least one hollow busbar into the at least one flow manifold.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts an example embodiment of a battery with metallic tabs extending outside the battery core, in accordance with embodiments described herein;

FIG. 2 depicts the battery shown in FIG. 1 with a pair of brackets attached to its tabs, in accordance with embodiments described herein;

FIGS. 3A and 3B depict front and rear isometric views, respectively, of an embodiment of a connection between a hollow busbar and the battery core of the battery depicted in FIG. 1, in accordance with embodiments described herein;

FIG. 4 depicts an example schematic of a serial connection between two batteries using a hollow busbar, in accordance with embodiments described herein;

FIG. 5 depicts an embodiment of a battery pack, in accordance with embodiments described herein;

FIG. 6 depicts an exploded view of a sample battery pack with components of a thermal management system, in accordance with embodiments described herein;

FIGS. 7A and 7B depict front and rear perspective views, respectively, of the battery assembly depicted in FIG. 6 with an embodiment of a thermal management system, in accordance with embodiments described herein;

FIG. 8 depicts an embodiment of a plenum usable with the battery assembly depicted in FIG. 6, in accordance with embodiments described herein;

FIG. 9 depicts an embodiment of a flow manifold usable with the battery assembly depicted in FIG. 6, in accordance with embodiments described herein;

FIG. 10 depicts an embodiment of a circular hollow busbar usable with the battery assembly depicted in FIG. 6, in accordance with embodiments described herein; and

FIG. 11 depicts an embodiment of a clamp joint usable with the battery assembly depicted in FIG. 6, in accordance with embodiments described herein.

### DETAILED DESCRIPTION

In view of the foregoing background, a need exists to manage the heat at critical regions of a battery system while minimizing space requirements and complexity of the BTMS. Accordingly, a thermal management system integrated to busbars of the battery system is proposed for battery assemblies with a plurality of battery cells.

In one embodiment, a battery comprises, in particular, an electrochemical cell that has at least two electrodes and an electrolyte arranged between the two electrodes. The electrodes include metallic current collectors laminated by active materials required in the cell chemistry. Since metallic collectors are, in some embodiments, about 200-300 times more thermally conductive than other components of the cell, they can be used as highways to remove the heat from the battery. More importantly, these current collectors bundle together and extend to the outside of the battery structure to form the battery terminals (tabs) and deliver the electrical current to the busbars.

In some of the embodiments disclosed herein, a thermal management system is integrated to the battery busbars where heat removal or heat addition can be efficiently applied. Busbars are assembly components to construct battery packs by electrically connecting individual battery cells. Embodiments disclosed herein introduce busbars with coolant cavities formed inside them, a coolant inlet manifold having a coolant cavity inlet, and a coolant outlet manifold having a coolant cavity outlet.

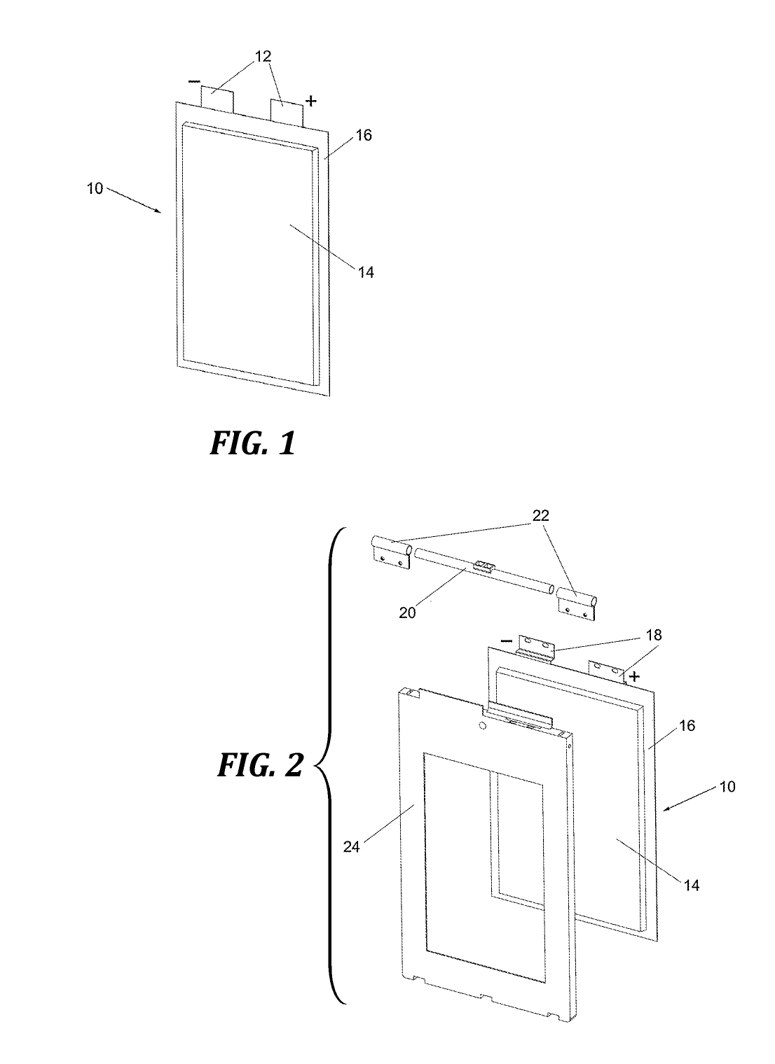

In FIG. 1, an embodiment of a battery 10 is shown. The single battery 10 has two metallic tabs 12 extended outside the battery core. The battery tabs 12, positive and negative, are electrically and thermally conductive, and are used for the purpose of electrical connection of the battery 10 to a load (for discharging) or a charger (for charging). The tabs 12 are internally connected to current collecting members inside the battery core that includes a stack of electrochemical cells 14. The stack of electrochemical cells 14 is encased in a case 16, which is electrically inert.

In the embodiment depicted in FIG. 1, the tabs 12 include a negative electrode and a positive electrode. In some embodiments, the negative electrode of the tabs 12 is made from a carbon material, such as graphite. In some embodiments, the positive electrode of the tabs 12 is made from a metal oxide, such as a layered oxide (e.g., a lithium cobalt oxide), a polyanion (e.g., a lithium iron phosphate), or a spinel (e.g., a lithium manganese oxide). In some embodiments, the tabs 12 are reversible (i.e., switch from being positive to negative or vice versa), depending on the direction of current flow through the electrochemical cells 14 of the battery 10.

In some embodiments, the electrochemical cells 14 include an electrolyte. In one example, the electrolyte is a lithium salt in an organic solvent. In other examples, the electrolyte is a mixture of organic carbonates (e.g, ethylene carbonate or diethyl carbonate) containing complexes of lithium ions.

In FIG. 2, the battery 10 is shown with a pair of brackets 18 attached to its tabs (i.e., tabs 12 depicted in FIG. 1). The brackets 18 are used to connect battery tabs to a hollow busbar 20 with one or more clamps 22. In some embodiments, the brackets 18 provide mechanical support for the tabs. In other embodiments, the brackets are made from a material that improves electrical and/or thermal conductivity between the tabs and the hollow busbar 20. In this way, the brackets 18 improve the electrical and/or thermal transport efficiencies between the battery tabs 12 and the hollow busbar 20.

In some embodiments, the hollow busbar 20 is made from a material or materials that exhibit particular electrical and thermal conductivities. In some examples, the material or materials of the hollow busbar 20 exhibit electrical conductivity greater than about 1×10⁶Ω⁻¹·m⁻¹ and thermal conductivity greater than about 40 W·m⁻¹·K⁻¹. In some examples, the material or materials of the hollow busbar 20 include one or more of copper, gold, silver, steel, zinc, or other metal materials.

In the embodiment depicted in FIG. 2, the battery 10 sits inside a housing tray 24, which contains the battery 10. The housing tray 24 provides mechanical integrity for battery assemblies. In some embodiments, the battery assemblies include a plurality of batteries, such as multiple instances of the battery 10. In other embodiments, the battery assemblies include a single battery, such as battery 10.

The hollow busbar 20 is configured to provide a passage for coolant flow. As is described in greater detail below, coolant flowing through the hollow busbar 20 is configured to transfer heat produced by the battery 10, or any other battery in the battery assembly, to a heat sink. In some embodiments, the heat sink is configured to use or dissipate the heat produced by the battery 10. In some embodiments, the coolant is a fluid (e.g., a liquid or a gas) that is capable of conducting the heat away from the battery 10.

In the depiction shown in FIG. 2, the one or more clamps 22 are loop clamps. In some embodiments the loop claims are made from a metallic material, such as galvanized steel, stainless steel, or aluminum. The loop clamps are configured to be secured around the hollow busbar 20 to the brackets 18. In some embodiments, the loop clamps also serve as an electrical and thermal connection between the brackets 18 and the hollow busbar 20.

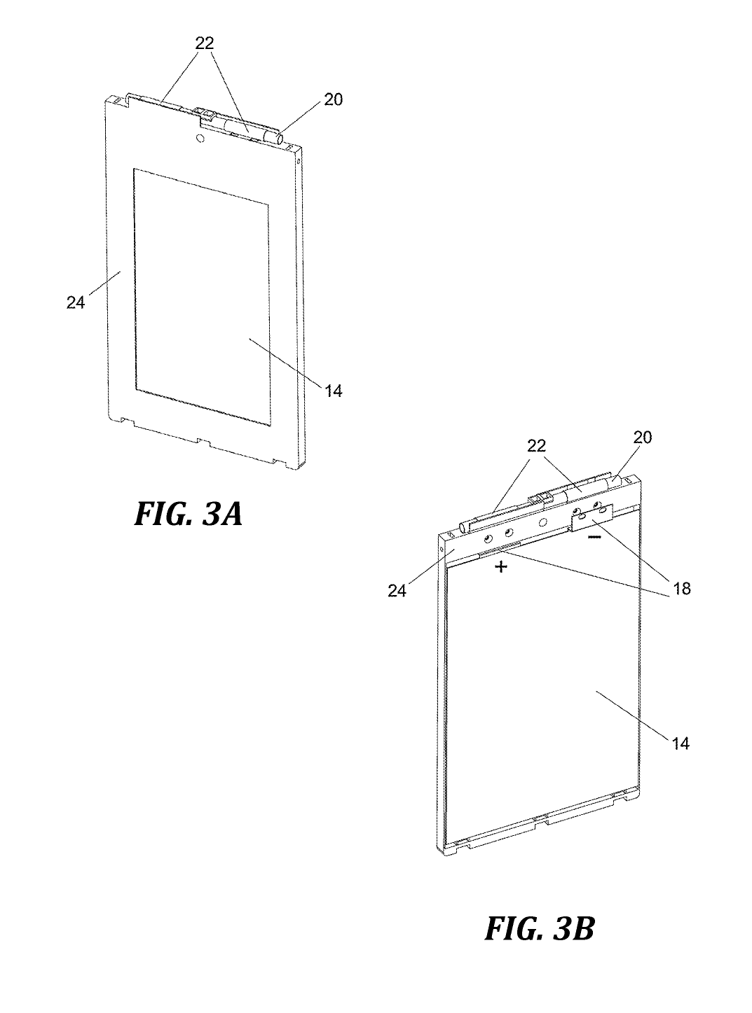

In FIGS. 3A and 3B, depicted are front and rear isometric views, respectively, of an embodiment of the connection between the battery core 14 and the hollow busbar 20. The battery core 14 is secured inside the housing tray 24. The top side of the tray 24 provides a cavity for the connection between the brackets 18 and the hollow busbar 20 through one or more clamps 22. In some embodiments, the cavity is concave and the hollow busbar 20 is cylindrical such that the cylindrical hollow busbar 20 fits in the concave cavity. In other embodiments, the cavity and the hollow busbar 20 have other shapes, such as a rectangular shape of each of the cavity and the hollow busbar 20.

In some implementations, it is advantageous to connect multiple batteries in series. In one embodiment, in hybrid and electric vehicles, a battery system includes several battery packs, where each battery pack contains several batteries. Arranging batteries in series allows for multiple batteries to fulfill the overall electrical storage capacity of the hybrid and electric vehicles. In some embodiments, the hybrid and electric vehicles require battery capacity of 25 kilowatt-hours (kWh) or more.

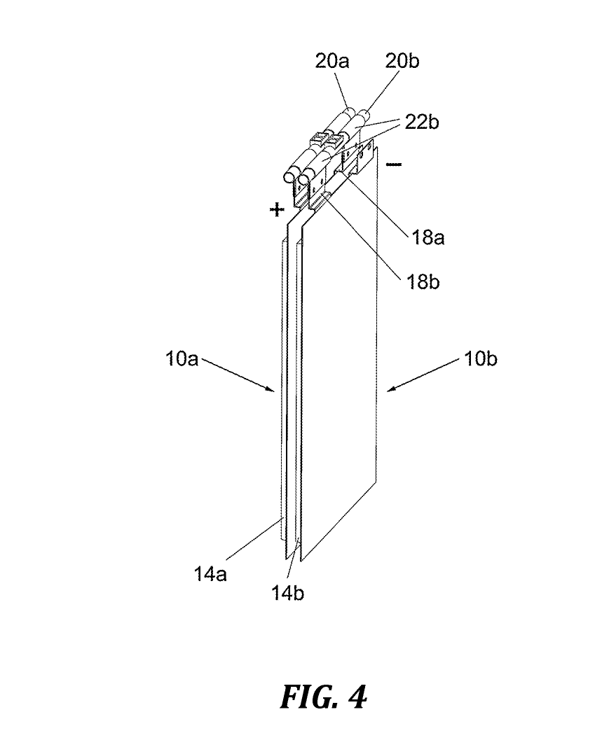

In FIG. 4, an example schematic of a serial connection between two batteries 10a and 10b is illustrated. For the sake of better illustration, battery housing trays are not shown. The hollow busbar 20b couples the bracket 18b on the positive tab of battery 10b to the bracket 18a on the negative tab of battery 10a. The connection between the hollow busbar 20b and brackets 18a and 18b is provided by clamp connectors 22b. The hollow busbar 20b provides an electrical connection between the positive tab of battery 10b and the negative tab of battery 10a so that the two batteries 10a and 10b are electrically coupled in series. The hollow busbar 20b is also thermally coupled to the battery 10a via the negative tab of battery 10a and to the battery 10b via the positive tab of battery 10b. In a cooling scenario, when a coolant flows through the hollow busbar 20b, heat from the batteries 10a and 10b is transferred to the hollow busbar 20b and the flowing coolant to be carried away from the batteries 10a and 10b.

The hollow busbar 20a is coupled to the positive terminal of the battery 10a and is configured to be coupled to a negative terminal of another battery. Thus, the hollow busbar 20a is configured to provide a serial connection with another battery (not shown in FIG. 4). This configuration can be repeated with a plurality of batteries and a plurality of hollow busbars, where the number of the plurality of batteries (e.g., x batteries) is one greater than the number of the plurality of hollow busbars (e.g., x−1 hollow busbars). In this example, each of the plurality of busbars provides a serial electrical connection between two of the plurality of batteries and provides thermal heat transfer from the two of the plurality of batteries.

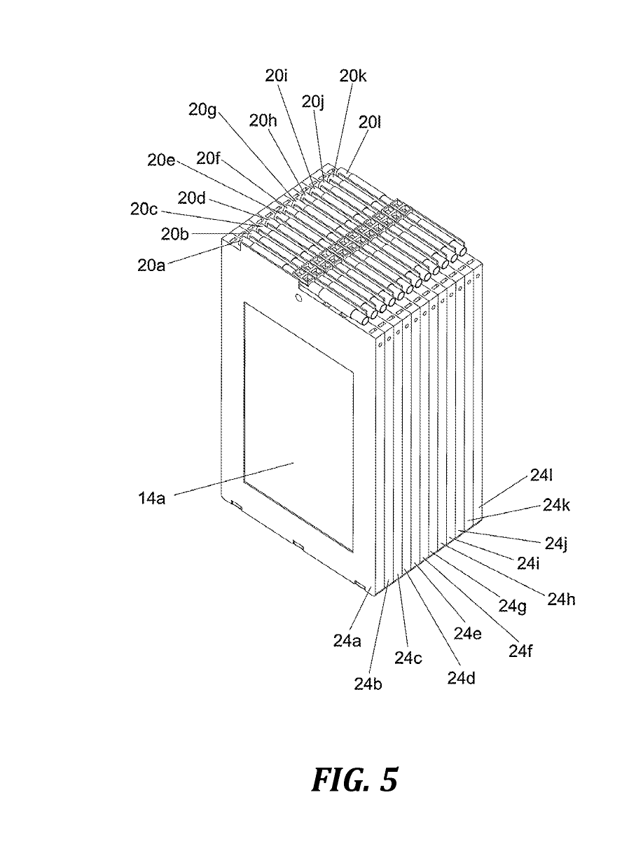

An embodiment of a battery pack with a plurality of batteries coupled in series via a plurality of hollow busbars is depicted in FIG. 5. The battery pack includes twelve batteries and their housing trays 24a to 24l. While any number of batteries may be used within the battery pack, twelve batteries are used in the depicted embodiment for the sake of illustration. Only the first electrode stack 14a of one battery is visible in the provided drawing; however, each housing trays 24a to 24l is configured to house at least one electrode stack of a different battery. The neighboring batteries are connected in series via hollow busbars 20a to 20l. The hollow busbars 20a to 20l couple the batteries in series using the configuration depicted in and discussed above with respect to FIG. 4.

As depicted in FIG. 5, the hollow busbars 20a to 20l electrically couple the batteries in series while permitting coolant flow through the hollow busbars 20a to 20l in parallel. This configuration permits heat transfer from the batteries to the coolant flow through the hollow busbars 20a to 20l, while connecting the batteries in series via the hollow busbars 20a to 20l.

As depicted in FIG. 5, housing trays 24a to 24l achieve a mechanically stable construction for the battery assembly. The housing trays 24a to 24l are configured to be in physical contact with one or more neighboring housing trays when the hollow busbars 20a to 20l are coupled to the tabs of the batteries. This arrangement increases the mechanical stability of the overall battery pack. In some embodiments, metallic or graphite-based housing trays in the battery pack are configured to dissipate heat from the batteries. In one example, the housing trays include fins configured for improved heat dissipation.

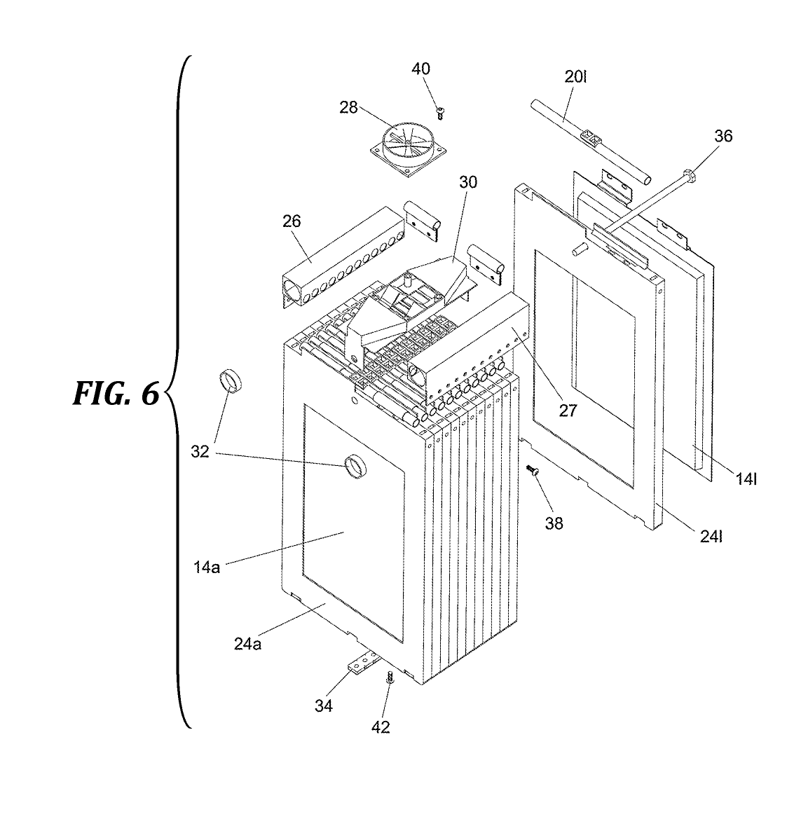

In FIG. 6, an exploded view of a sample battery assembly with components of a thermal management system is shown. A pair of flow manifolds 26 and 27 are provided to distribute and/or collect coolant into and/or from the hollow busbars. In the depicted embodiment, an end of each hollow busbar is fixed in a hole of the flow manifold 26 and another end of each hollow busbar is fixed in a hole of the flow manifold 27. In this arrangement, coolant may pass from the flow manifold 26 to the flow manifold 27 in parallel via the hollow busbars and/or from the flow manifold 27 to the flow manifold 26 in parallel via the hollow busbars.

In one embodiment, at the center of each hollow busbar, holes are provided for air flow. In one embodiment, a fan 28 is mounted at the top of the battery assembly and forces air to flow through manifolds 26 and 27 and then into the hollow busbars. The fan 28 can function either as a blower or a suction device. In one embodiment, in order to achieve a substantially uniform flow rate from/into each busbar, a plenum 30 is mounted below the fan 28.

In some embodiments, the battery assembly includes components 32 for sealing a connection between an external coolant supply channel and the manifolds 26 and 27. In some embodiments, the battery assembly includes part 34 to enforce the structure of the battery assembly at the bottom. In one example, the part 34 is a plastic or metallic rail. In some embodiments, the battery assembly includes part 36 through the housing trays 24a to 24l to enforce the structure of the battery assembly at the top. In one example, the battery assembly includes fasteners 38, 40 and 42 used to respectively mount the manifolds 26 and 27, the fan 28, and the plastic rails 34 on the battery assembly. In some examples, the fasteners 38, 40, and 42 include one or more of screws, bolts, rivets, or any other fastener.

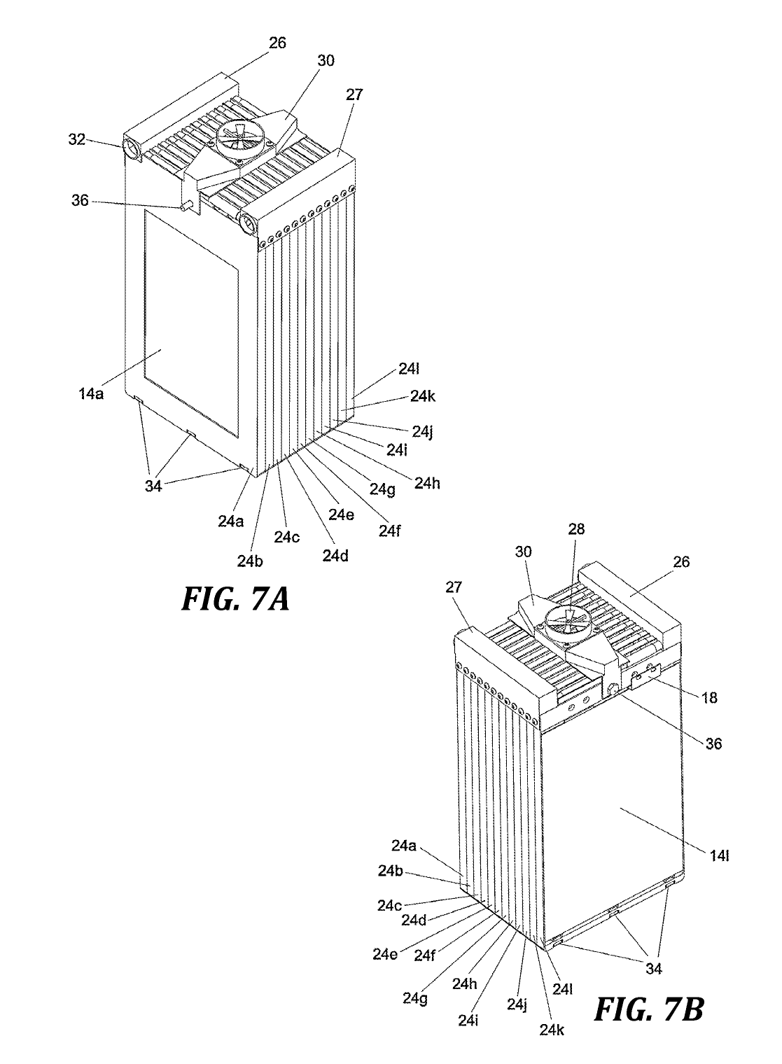

In FIGS. 7A and 7B, front a rear perspective views, respectively, are shown of the battery assembly described above and depicted in FIG. 6. The battery assembly includes an embodiment of a thermal management system, with the pair of manifolds 26 and 27 coupled via parallel hollow busbars, the fan 28, and the plenum 30. The connection between different components of the thermal management system, as assembled from the exploded view depicted in FIG. 6, is illustrated.

As shown in FIG. 7B, one of the brackets 18 coupled to an electrode of one polarity (i.e., positive or negative) of the electrode stack 141 is accessible. Similarly, an electrode of the opposite polarity (i.e., positive or negative) or a bracket coupled to the electrode of the electrode stack 14a is accessible. These connections form electrodes of the entire battery back, including the serially-connected batteries inside of the housing trays 24a to 24l.

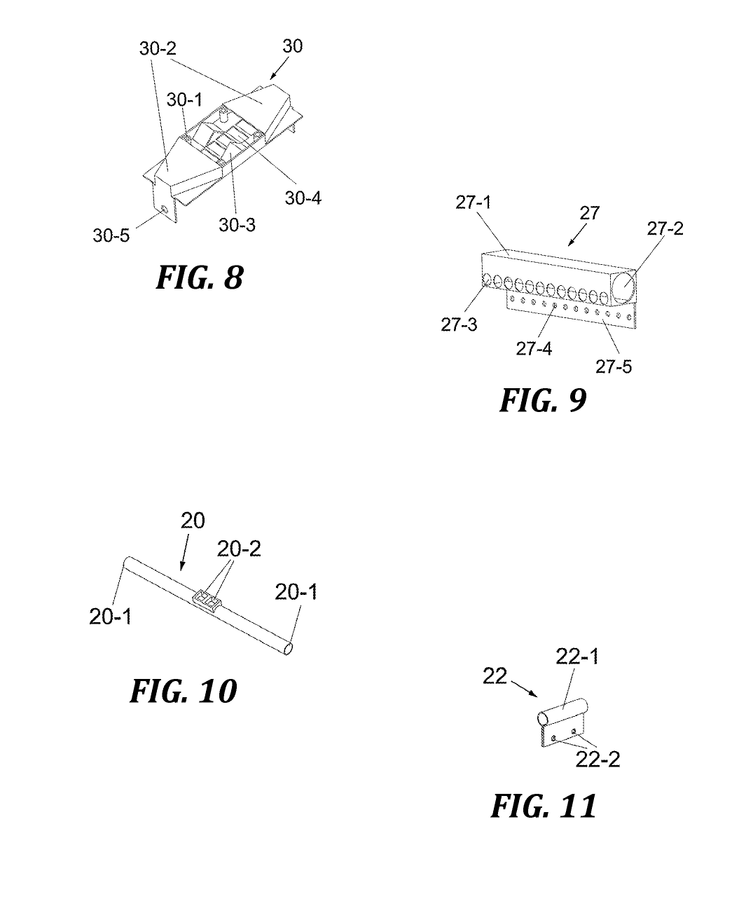

In FIG. 8, an embodiment of the plenum 30, including design details, is shown. To mount the fan 28 on the top of the plenum, fastener holes 30-1 are depicted at the corners of the top opening of the plenum 30. Cavities 30-2 are located around the top opening. In the embodiment shown in FIG. 8, the cavities 30-2 have varying cross-sections. In the depicted embodiment, the plenum 30 includes wedge-shaped parts 30-3 configured to direct the flow of air to or from the fan 28.

The plenum 30 also includes openings 30-4 at the bottom. In one embodiment, the openings 30-4 at the bottom of the plenum 30 are configured to align with holes in the hollow busbars in the battery pack when the plenum 30 is located on the battery pack. The alignment of the openings 30-4 with the holes in the hollow busbars permits air flow between the plenum 30 and the hollow busbars.

In one embodiment, the varying cross-sectional shape of the cavities 30-2 and the size and location of the wedge-shaped parts 30-3 are selected to increase the uniformity of flow rate from and/or to all the rectangular openings 30-4 at the bottom of the plenum 30. In other embodiments, the varying cross-sectional shape of the cavities 30-2 and the size and location of the wedge-shaped parts 30-3 are selected to provide particular flow rates through the individual hollow busbars to improve uniformity of temperature of each battery in the battery pack. In some embodiments, the plenum 30 includes holes 30-5. When the plenum 30 is fixed on top of a battery assembly with a bolt (e.g., the bolt 36 shown in FIGS. 5-7), the holes 30-5 are configured to receive the bolt 36.

In FIG. 9, a sample design for the flow manifold 27 is shown. While flow manifold 26 is not depicted in FIG. 9, flow manifold 26 can be configured in similar ways to flow manifold 27. The flow manifolds are configured to distribute coolant through hollow busbars (e.g., the busbars 20a to 20l depicted in FIG. 5).

In some embodiments, the flow manifold 27 is constructed of a duct or channel 27-1. In some embodiments, the duct or channel 27-1 is connected to an external coolant channel through one end or both ends of the duct or channel 27-1. In FIG. 9, an opening 27-2 at one end of the duct or channel 27-1 is shown. Ends of each busbar (e.g., the busbars 20a to 20l depicted in FIG. 5) are inserted (and optionally sealed) into coolant distribution holes 27-3 of the flow manifold. In accordance with the twelve batteries depicted in the sample battery assembly design of FIG. 7, there are twelve coolant distribution holes 27-3 on the flow manifold 27.

In some embodiments, the flow manifolds are configured to be fixed on structure of the battery assembly. In the sample battery assembly depicted in FIG. 7, the flow manifolds 26 and 27 are mounted on the top edges of the battery pack using fasteners (e.g., fasteners 38 depicted in FIG. 6) through holes 27-4 in the plate 27-5 (see FIG. 9).

In some embodiments, the flow manifolds 26 and 27 are made from a material that is less electrically conductive than the material of the hollow busbars. This reduces the likelihood that electrical charge carried by the hollow busbars leaks out of the serial connection of the batteries via the manifolds 26 and 27. In some embodiments, the flow manifolds 26 and 27 are made from a material that has an electrical conductivity less than about 1 Ω⁻¹·m⁻¹. In some embodiments, the flow manifolds 26 and 27 are made from a material that is less thermally conductive than the material of the hollow busbars. This increases the likelihood that heat transferred from the batteries to the hollow busbar is carried by the coolant instead of passed to the manifolds 27 and then to the housing trays. In some embodiments, the flow manifolds 26 and 27 are made from a material that has a thermal conductivity less than about 5 W·m⁻¹·K⁻¹.

In FIG. 10, an embodiment of a circular hollow busbar 20 is shown. In conventional battery assemblies, busbars provide electrical connection between batteries; however, in embodiments described herein, hollow busbars are introduced to integrate the battery thermal management system into the busbars. In some embodiments, ends 20-1 of each busbar 20 are mounted at the holes of flow manifolds (e.g., flow manifolds 26 and 27 depicted in FIGS. 6 and 7), and openings 20-2 in the middle of each busbar 20 are located to be under openings of a plenum (e.g., openings 30-4 of plenum 30 depicted in FIG. 8). When a pump or fan is working, coolant flows in cavities of busbars and absorbs heat from batteries via the busbars. In some examples, the material or materials of the hollow busbar 20 exhibit electrical conductivity greater than about 1×10⁶Ω⁻¹·m⁻¹ and thermal conductivity greater than about 40 W·m⁻¹·K⁻¹. In some examples, the material or materials of the hollow busbar 20 include one or more of copper, gold, silver, steel, zinc, or other metal materials.

In FIG. 11, an embodiment of a clamp joint 22 for connecting a hollow busbar (e.g., hollow busbar 20 shown in FIG. 10) to a battery bracket (e.g., battery bracket 18 depicted in FIG. 4) is shown. The clamp joint 22 is configured to connect the heat source (e.g., the battery) to the heat sink (e.g., a coolant flow in the hollow busbar) and configured to be electrically connected to the battery. In the embodiment shown in FIG. 11, a round part 22-1 of the clamp 22 is configured to hold a hollow busbar (e.g., to hold the busbar 20 inside the circular part 22-1, as shown in FIG. 4). In some embodiments, the connection between the clamp 22 and the battery cell is through brackets (e.g., brackets 18 in FIG. 4). Terminal brackets slide into the slit of the clamp and the connection is secured with a fastener (e.g., a screw and a nut, a rivet, etc.). The holes 22-2 are provided for fasteners to fasten the clamp 22 to the bracket.

In some embodiments, the clamp 22 is made from a material or materials that exhibit particular electrical and thermal conductivities. In some examples, the clamp 22 is made from a material that is similar to a material of a hollow busbar (e.g., hollow busbar 20 depicted in FIG. 10). In some examples, the material or materials of the clamp 22 exhibit electrical conductivity greater than about 1×10⁶Ω⁻¹·m⁻¹ and thermal conductivity greater than about 40 W·m⁻¹·K⁻¹. In some examples, the material or materials of the hollow busbar 20 include one or more of copper, gold, silver, steel, zinc, or other metal materials.

The embodiments disclosed herein may be practiced for different batteries and various assembly designs. The above description is intended to enable the person skilled in the art to practice the invention, and it is not intended to detail all the possible variations and modifications the will become apparent to the skilled worker upon reading the description. It is intended that all such modifications and variations be included within the scope of the invention that is defined by the following claims. The claims are intended to cover the indicated elements in any arrangement that is effective to meet the objective intended for the invention, unless the context specifically indicates the contrary.

The embodiments of the invention in which an exclusive property or privilege is claimed are defined as follows:

1. A battery assembly comprising:
a plurality of batteries operably positioned to be charged and discharged, wherein at least a first battery and a second battery of the plurality of batteries includes a stack of electrochemical cells encased in an electrically inert case, with a pair of battery tabs outwardly extended from the case, wherein at least the first battery and the second battery in the battery assembly are configured to be electrically connected through their battery tabs with one or more hollow busbars forming a passage for a coolant flow.

2. The battery assembly of claim 1, wherein the battery tabs are configured to be connected to the one or more hollow busbars with thermally and electrically conductive joints.

3. The battery assembly of claim 1, wherein the one or more hollow busbars comprise openings for coolant inlet and coolant outlet.

4. The battery assembly of claim 1, wherein the one or more hollow busbars are configured to electrically connect the battery tabs of adjacent batteries in the battery assembly.

5. The battery assembly of claim 1, further comprising:
at least one flow manifold configured to be used in a stacking direction of the batteries, wherein the at least one flow manifold has at least one opening for coolant flow to and from an external source, and a least one opening for coolant flow to and from the one or more hollow busbars.

6. The battery assembly of claim 5, wherein at least one opening of the one or more hollow busbars is connected to an opening on the at least one flow manifold such that flow of coolant is permitted either from the flow manifold into the hollow busbar or from the hollow busbar into the flow manifold.

7. The battery assembly of claim 1, further comprising:
a fan or a pump configured to drive the coolant flow within the one or more hollow busbars.

8. The battery assembly of claim 1, wherein the coolant is a gas or liquid and wherein a device configured to force the coolant flow is one or more of a fan, a blower, or a pump.

9. The battery assembly of claim 1, wherein the coolant flow inside the one or more hollow busbars is selected to be used for one of cooling or heating effects.

10. The battery assembly of claim 1, wherein the stack of electrochemical cells forms an electrode stack, and wherein the electrode stack comprises prismatic batteries.

11. A busbar for use in a battery assembly, comprising:
a hollow busbar configured to form a passage for coolant flow from a coolant inlet to a coolant outlet;
wherein the busbar is configured to attach to a plurality of batteries within the battery assembly via battery tabs extending from individual batteries in order to provide thermal communication between the busbar and the plurality of batteries and to provide electrical communication between the plurality of batteries.

12. The busbar of claim 11, wherein the battery tabs are connected to the hollow busbar with thermally and electrically conductive joints.

13. The busbar of claim 11, wherein the hollow busbar is configured to electrically connect the battery tabs of adjacent batteries in the battery assembly.

14. The busbar of claim 11, wherein the hollow busbar is configured to attach to at least one flow manifold configured to provide coolant flow through the hollow busbar.

15. The busbar of claim 14, wherein the at least one flow manifold is configured to provide coolant flow either from the flow manifold into the at least one hollow busbar or from the at least one hollow busbar into the flow manifold.

16. The busbar of claim 11, wherein the coolant is a gas or a liquid.

17. The busbar of claim 11, wherein the flow of the coolant inside the busbars is selected to be used for one of cooling and heating effects.

18. The busbar of claim 11, wherein the plurality of electrochemical cells comprises prismatic batteries.

19. A flow manifold configured to attach to a busbar wherein the busbar includes a hollow busbar configured to form a passage for coolant flow from a coolant inlet to a coolant outlet, wherein the busbar is configured to attach to a plurality of batteries within the battery assembly via battery tabs extending from individual batteries in order to provide thermal communication between the busbar and the plurality of batteries and to provide electrical communication between the plurality of batteries.

20. The flow manifold of claim 19, wherein the flow manifold has at least one opening for a coolant flow from and to an external source, and a least one opening for coolant flow from and to a hollow busbar.

21. The flow manifold of claim 19, wherein the flow manifold is configured to permit the coolant flow either from the flow manifold into the hollow busbar or from the hollow busbar into the flow manifold.

22. A cooling system for a battery assembly, comprising:
at least one hollow busbar configured to form a passage for coolant flow from a coolant inlet to a coolant outlet wherein the at least one hollow busbar is configured to attach to a plurality of batteries within the battery assembly via battery tabs extending from individual batteries in order to provide thermal communication between the at least one hollow busbar and the plurality of batteries and to provide electrical communication between the plurality of batteries; and
at least one flow manifold in fluid communication with the at least one hollow busbar.

23. The cooling system of claim 22, wherein the at least one flow manifold is configured to permit the coolant flow either from the at least one flow manifold into the at least one hollow busbar or from the at least one hollow busbar into the at least one flow manifold.
